(19) United States
(12) Patent Application Publication
(10) Pub. No.: US 2010/0313542 A1
(43) Pub. Date: Dec. 16, 2010

(54) JET ENGINE SCREEN

(76) Inventors: Emmanuel Bansa, Flossmoor, IL (US); Connie Bansa, Flossmoor, IL (US)

Correspondence Address: LAW OFFICE OF JERRY D. HAYNES , P.A, P.O. Box 350392, Fort Lauderdale, FL, 33335, US

(21) Appl. No.: 12/483,208

(22) Filed: Jun. 11, 2009

(51) Int. Cl. F02G 3/00

(52) U.S. Cl. 60/39.092

(57) ABSTRACT

The present invention relates to a jet screen designed to protect a jet engine comprising: a conical shaped perimeter; a concaved metal grid within the perimeter; and a plurality of bolts, said bolts provide a mechanism to secure the screen to an intake opening of a jet engine. The metal grid may be manufactured by using a light metal alloy. The perimeter of the screen extends around the circumference of the intake opening and the jet screen completely covers the intake opening. The metal grid according to the present invention provides sufficient spacing to avoid interference with air intake into the intake opening and to prevent entry of foreign objects into the intake opening.

### BACKGROUND OF THE INVENTION

1. Field of Invention

The present invention relates to a screen cover for a jet engine.

2. Description of Related Art

Jet engines may encounter various conditions while a jet plane is in flight. One of the conditions that may be encountered is the possibility of foreign objects being thrusted into the jet engine. Foreign objects ingested into a running jet engine may cause hazardous and some times life-threatening conditions for the passengers of the jet plane. A jet engine that inadvertently ingests a foreign object may suffer damage to the compression stage or other components of the jet engine. The damage to the jet engine may occur immediately and affect operation of the engine and cause the necessity for an emergency landing or crash of the plane.

Various systems have been developed to address the problem of foreign object intake into a jet engine. U.S. Pat. No. 5,411,224 discloses a protective guard as a cover for a jet engine that uses specially shaped titanium rods that extend forward of the jet engine and along an incline path to form a 30° degree angle with the central longitudinal axis of the guard.

Another exemplary protective screen is disclosed in U.S. Pat. No. 4,149,689 which discusses a frustoconical array of multiplicity of straight resilient metal rods surrounding a front end of the nacelle to form a cage like structure, where the rods converge forwardly from the front end and have their forward ends held together by a point tip lying substantially in line with the nacelle axis.

U.S. Pat. No. 3,196,598 discloses yet another exemplary screen for a jet engine. The screen disclosed in the 598 patent provides a deflector having a surface that is angularly disposed to the axis of the engine nacelle and the base of the deflective surface is located ahead of the nacelle inlet.

Although some of the guards developed in the prior art have provided some means to address the protection of a jet engine, further development in the area of jet engine screens needs to be developed in order to make an effective and practical screen for a jet engine.

### SUMMARY OF THE INVENTION

The present invention relates to a jet screen designed to protect a jet engine comprising: a conical shaped perimeter; a concaved metal grid within the perimeter; and a plurality of bolts, said bolts provide a means to secure the screen to an intake opening of a jet engine. The metal grid may be manufactured by using a light metal alloy. The perimeter of the screen extends around the circumference of the intake opening and the jet screen completely covers the intake opening. The metal grid according to the present invention provides sufficient spacing to avoid interference with air intake into the intake opening and to prevent entry of foreign objects into the intake opening.

### BRIEF DESCRIPTION OF DRAWINGS

FIG. 1 depicts a jet screen according to the present invention.

### DETAILED DESCRIPTION

The present invention provides a jet screen that may be utilized to prevent the ingestion of foreign objects such as flying birds into the running jet engine on a plane. The present invention provides a cone shaped screen that may be bolted over a jet engine to deflect flying birds entering into the turbine and therefore damaging or substantially affecting the operation of the jet engine.

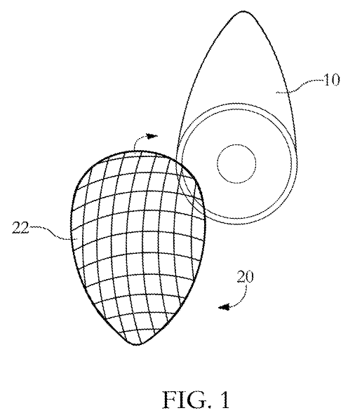

A jet screen 20 is depicted in FIG. 1. The jet screen 20 may be bolted onto a jet engine 10. The jet screen 20 has a cone shape and therefore provides a means to deflect foreign objects that may come within the input airflow of the jet engine 10. The jet screen 20 may be manufactured of a light metal alloy and may vary in size and shape to accommodate different size engines and aircrafts.

The jet screen 20 includes a metal grid 22 that has sufficient spacing to allow adequate air flow into the jet engine for operational purposes but to prevent the inward flow of foreign objects such as a flying bird or otherwise. The grid 22 has a concave shape and extends outwardly from the center vertex of the jet engine. The conical shape of the jet screen 20 extends around the circumference of the jet engine intake opening. The jet screen 20 completely covers the opening and therefore prevents the entry of foreign objects or birds into the jet engine. The jet screen 20 may be adjusted in size for various jet engines and easily bolted into place to withstand the high speed of the jet engine and secure enough to deal with the temperature changes that occur during flight. The present invention is uniquely designed so that airflow is not reduced into the jet engine but yet adequately protects the engine from the intake of foreign objects.

What is claimed is:

1. A jet screen designed to protect a jet engine comprising:
a. a conical shaped perimeter;
b. a concaved metal grid within the perimeter; and
c. a plurality of bolts, said bolts provide a means to secure the screen to an intake opening of a jet engine.

2. The jet screen according to claim 1, where the metal grid is manufactured by using a light metal alloy.

3. The jet screen according to claim 1, where the perimeter of the screen extends around the circumference of the intake opening.

4. The jet screen according to claim 3, where the jet screen completely covers the intake opening.

5. The jet screen according to claim 1, where the metal grid provides sufficiently spacing to avoid interference with air intake into the intake opening and to prevent entry of foreign objects into the intake opening.

6. The jet screen according to claim 1, where the perimeter may be adjusted to fit the intake opening.
